(19) United States
(12) Patent Application Publication
(10) Pub. No.: US 2026/0332905 A1
(43) Pub. Date: Oct. 22, 2026

(54) INFORMATION PROCESSING DEVICE, SYSTEM, INFORMATION PROCESSING METHOD, INFORMATION PROCESSING PROGRAM, AND COMPUTER SYSTEM

(71) Applicant: Sony Interactive Entertainment Inc., Tokyo (JP)

(72) Inventors: Hideaki Iwaki, Kanagawa (JP); Naoyuki Miyada, Tokyo (JP); Masayoshi Mizuno, Tokyo (JP)

(73) Assignee: Sony Interactive Entertainment Inc., Tokyo (JP)

(21) Appl. No.: 19/157,559

(22) PCT Filed: Mar. 17, 2023
(86) PCT No.: PCT/JP2023/010678

§ 371 Date: Aug. 18, 2025

(51) Int. Cl. H04N 25/47; G06T 7/20; G06V 10/25; H04N 23/611

(52) U.S. Cl. CPC H04N 25/47; G06T 7/20; G06V 10/25; H04N 23/611; G06V 2201/07

(57) ABSTRACT

Provided is an information processing device including a detection section that detects an attention point in a detection target on the basis of an output of a first sensor and an event signal generated with temporal correlation with time for specifying the output of the first sensor among event signals generated by a second sensor including an event-based sensor for asynchronously generating event signals when detecting a change in the intensity of light incident on each pixel.

### TECHNICAL FIELD

The present invention relates to an information processing device, a system, an information processing method, an information processing program, and a computer system.

### BACKGROUND ART

An event-based sensor in which a pixel that detects a change in the intensity of incident light generates a signal asynchronously in time has been known. The event-based sensor is advantageous in that it can operate at high speeds with low power in comparison with a frame-based vision sensor, specifically, an image sensor such as a charge-coupled device (CCD) and a complementary metal-oxide-semiconductor (CMOS), which scans all pixels for each predetermined cycle. The techniques related to such an event-based sensor are described in, for example, PTL 1 and PTL 2.

### CITATION LIST

### Patent Literature

### [PTL 1]

Japanese Translations of PCT for Patent No. 2014-535098

### [PTL 2]

Japanese Patent Laid-open No. 2018-85725

### SUMMARY

### Technical Problem

However, although the above-described advantage of the event-based sensor has been known, it is difficult to say that a utilization method in combination with other devices has been sufficiently proposed.

Therefore, an object of the present invention is to provide an information processing device, a system, an information processing method, an information processing program, and a computer system that can perform detection with high accuracy while suppressing latency by detecting an attention point in a detection target by using a sensor and an event-based sensor both of which perform an output with temporal correlation with each other.

### Solution to Problem

According to an aspect of the present invention, provided is an information processing device including a detection section that detects an attention point in a detection target on the basis of an output of a first sensor and an event signal generated with temporal correlation with time for specifying the output of the first sensor among event signals generated by a second sensor including an event-based sensor for asynchronously generating event signals when detecting a change in intensity of light incident on each pixel.

According to another aspect of the present invention, provided is a system including a first sensor, a second sensor that includes an event-based sensor for asynchronously generating event signals when detecting a change in intensity of light incident on each pixel, and a detection section that detects an attention point in a detection target on the basis of an output of the first sensor and the event signal generated with temporal correlation with time for specifying the output of the first sensor among the event signals.

According to still another aspect of the present invention, provided is an information processing method including a first reception step of receiving an output of a first sensor, a second reception step of receiving event signals generated by a second sensor including an event-based sensor for asynchronously generating event signals when a change in intensity of light incident on each pixel is detected, and a detection step of detecting an attention point in a detection target on the basis of the output of the first sensor and an event signal generated with temporal correlation with time for specifying the output of the first sensor among the event signals.

According to still another aspect of the present invention, provided is an information processing program that causes a computer to realize a function of receiving an output of a first sensor, a function of receiving event signals generated by a second sensor including an event-based sensor for asynchronously generating event signals when a change in intensity of light incident on each pixel is detected, and a function of detecting an attention point in a detection target on the basis of the output of the first sensor and an event signal generated with temporal correlation with time for specifying the output of the first sensor among the event signals.

According to still another aspect of the present invention, provided is a computer system including a memory for storing a program code and a processor for processing the program code to execute an operation, in which the operation includes receiving an output of a first sensor, receiving event signals generated by a second sensor including an event-based sensor for asynchronously generating event signals when a change in intensity of light incident on each pixel is detected, and detecting an attention point in a detection target on the basis of the output of the first sensor and an event signal generated with temporal correlation with time for specifying the output of the first sensor among the event signals.

### BRIEF DESCRIPTION OF DRAWINGS

FIG. 1 is a block diagram for depicting an outline configuration of a system according to an embodiment of the present invention.

FIG. 2 is a diagram for explaining an example of detecting a person in an embodiment of the present invention.

FIG. 3 is a diagram for explaining the relation between an RGB image signal and an event signal in an embodiment of the present invention.

FIG. 4 is a flowchart for depicting an example of a processing method according to an embodiment of the present invention.

FIG. 5 is another flowchart for depicting an example of the processing method according to an embodiment of the present invention.

FIG. 6 is still another flowchart for depicting an example of the processing method according to an embodiment of the present invention.

FIG. 7 is still another flowchart for depicting an example of the processing method according to an embodiment of the present invention.

FIG. 8 is a block diagram for depicting an outline configuration of a detection section according to an embodiment of the present invention.

FIG. 9 is still another flowchart for depicting an example of the processing method according to an embodiment of the present invention.

FIG. 10 is another block diagram for depicting an outline configuration of a system according to an embodiment of the present invention.

FIG. 11 is still another flowchart for depicting an example of the processing method according to an embodiment of the present invention.

FIG. 12 is still another flowchart for depicting an example of the processing method according to an embodiment of the present invention.

### DESCRIPTION OF EMBODIMENT

Hereinafter, several embodiments of the present invention will be described in detail with reference to the accompanying drawings. It should be noted that, in the present specification and the drawings, constitutional elements having substantially the same functional configurations will be denoted by the same reference signs, and duplicate descriptions will be omitted.

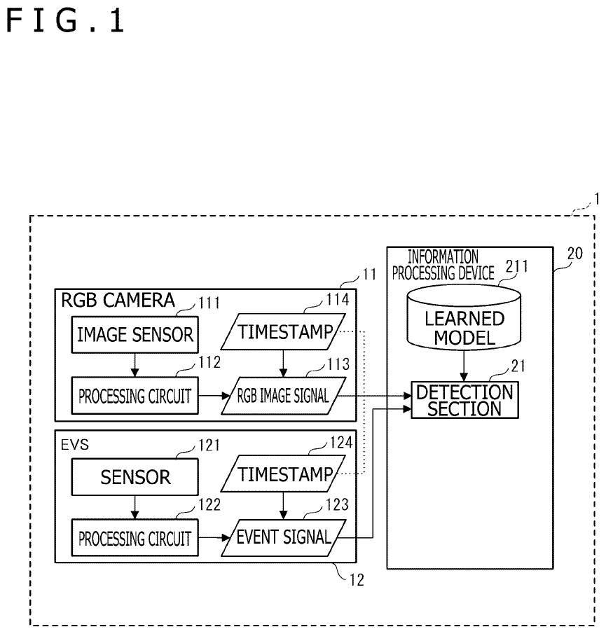

FIG. 1 is a block diagram for depicting an outline configuration of a system according to an embodiment of the present invention. A system 1 includes an RGB camera 11, an event-based vision sensor (EVS) 12, and an information processing device 20. The RGB camera 11 includes an image sensor 111 that is a first sensor and a processing circuit 112 connected to the image sensor 111. The image sensor 111 generates an RGB image signal 113 by scanning all pixels synchronously in time, for example, at a predetermined cycle or at a predetermined timing according to a user operation. The processing circuit 112 converts, for example, the RGB image signal 113 into a format suitable for storage and transmission. In addition, the processing circuit 112 gives a timestamp 114 to the RGB image signal 113.

The EVS 12 is an example of a second sensor that generates an event signal when the sensor detects a change in the intensity of light, and is an example of a sensor also referred to as a dynamic vision sensor (DVS) or an event-based vision sensor (EVS). The EVS 12 includes a sensor 121 that is the second sensor configuring a sensor array, and a processing circuit 122 connected to the sensor 121. The sensor 121 is an event-based sensor that includes a light receiving element and generates an event signal 123 when detecting a change in the intensity of light incident on a pixel basis, more specifically, a change in luminance exceeding a preset predetermined value. Since the sensor 121 that does not detect a change in the intensity of incident light does not generate the event signal 123, the event signal 123 is generated asynchronously in time in the EVS 12.

The event signal 123 output via the processing circuit 122 includes identification information (for example, the position of a pixel) of the sensor 121, polarity (rise or fall) of a change in luminance, and a timestamp 124. In addition, when a change in luminance is detected, the EVS 12 can generate the event signal 123 at a frequency significantly higher than the generation frequency of the RGB image signal 113 (the frame rate of the RGB camera 11).

In the present embodiment, the timestamp 114 given to the RGB image signal 113 and the timestamp 124 given to the event signal 123 are associated with each other in time. Specifically, for example, by providing time information used to generate the timestamp 124 by the EVS 12 to the RGB camera 11, the timestamp 114 can be associated with the timestamp 124. Alternatively, in the case where time information for generating the timestamps 114 and 124 is independent between the RGB camera 11 and the EVS 12, the offset amount of the timestamps is calculated on the basis of the time when a specific event (for example, a change in a subject throughout an image) occurred, so that the timestamp 114 and the timestamp 124 can be associated with each other after the occurrence.

In addition, in the present embodiment, the sensor 121 of the EVS 12 is associated with one or more pixels of the RGB image signal 113, and the event signal 123 is generated according to a change in the intensity of light in one or more pixels of the RGB image signal 113, by the calibration procedures of the RGB camera 11 and the EVS 12 executed in advance. More specifically, for example, the sensor 121 can be associated with one or more pixels of the RGB image signal 113 by imaging a common calibration pattern between the RGB camera 11 and the EVS 12 and calculating association parameters between the camera and the sensor from internal parameters and external parameters of the RGB camera 11 and the EVS 12.

The information processing device 20 is implemented, for example, by a computer having a communication interface, a processor, and a memory, and includes a function of a detection section 21 realized in such a manner that a processor for processing program codes to execute operations is operated according to a program stored in a memory or received via a communication interface.

The detection section 21 detects an attention point in a detection target on the basis of the RGB image signal 113 generated by the image sensor 111 that is the first sensor and the event signal 123 generated by the sensor 121 that is the second sensor. In the present embodiment, a case where the detection target is a person will be described as an example.

The detection section 21 uses at least one joint of a person who is the detection target as an attention point and calculates coordinate information thereof.

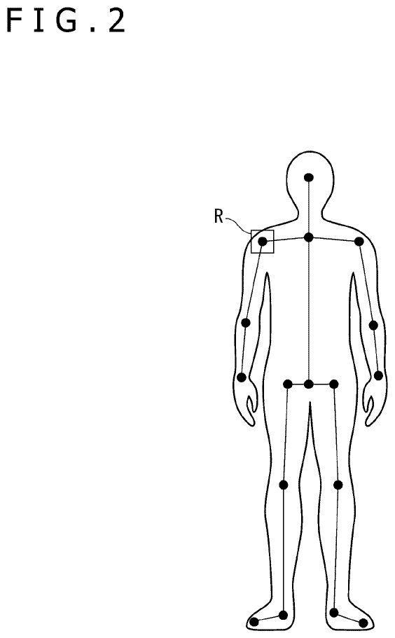

FIG. 2 is a diagram for explaining an example of detecting a person. As depicted in FIG. 2, the detection section 21 uses a plurality of joints of the person as attention points and calculates coordinate information of each joint. The example in FIG. 2 depicts an example in which 17 joints such as the head, shoulders, elbows, wrists, knees, ankles, and toes are used as the attention points.

On the basis of, for example, a learned model 211, the detection section 21 uses a plurality of joints of a user from the RGB image signal 113 as the attention points and calculates coordinate information indicating the position of each joint.

The learned model 211 can be constructed in advance by, for example, executing supervised learning in which an image of a person having a plurality of joints is used as input data, the plurality of joints of the person are used as the attention points, and coordinate information indicating the position of each joint is used as correct answer data. It should be noted that a detailed description of specific methods of machine learning is omitted because various known techniques can be used. In addition, the detection section 21 may be provided with a relation learning section, and each time the RGB image signal 113 is input, the learned model 211 may be updated by learning the relation between an image based on the input RGB image signal 113 and coordinate information indicating the positions of the joints.

In addition, the event signal 123 may be used when processing is performed by the detection section 21. For example, an object existing in a continuous pixel region where occurrence of an event of the same polarity is depicted in the event signal 123 may be detected as a person, and the detection processing described above may be performed for the corresponding part of the RGB image signal 113.

The detection section 21 may set an interest region including at least a part of the detection target. The interest region is a region including at least a part of the detection target, and is an attention region to be subjected to tracking processing or the like. As depicted in, for example, FIG. 2, for each attention point (joint) of the person, the detection section 21 sets a square having a predetermined size centering on the attention point as an interest region R. It should be noted that, in the example of FIG. 2, the interest region R is illustrated only for the attention point of one shoulder, but the detection section 21 may set the interest region R for each of all the attention points of the person, or may set the interest region R only for some of the attention points. It may be possible for the user to specify to which attention point the interest region R is set.

As described above, the detection section 21 detects the attention point on the basis of the RGB image signal 113 generated by the image sensor 111 that is the first sensor and the event signal 123 generated by the sensor 121 that is the second sensor, but detects the attention point in the interest region R in the case where the interest region R has been set on the basis of the RGB image signal 113 of the previous frame or the like. It should be noted that, in the case where a plurality of interest regions R have been set, the detection section 21 detects the attention point for each interest region.

The detection section 21 selects whether to refer to the RGB image signal 113 or whether to refer to the event signal 123 when detecting the attention point according to the timing when the image sensor 111 generates the RGB image signal 113.

In the RGB camera 11, as described above, the image sensor 111 scans all the pixels synchronously in time to generate the RGB image signal 113 at a constant frame rate. Then, on the basis of the RGB image signal 113 generated by the RGB camera 11, the detection section 21 calculates coordinate information of the attention point of the person as the detection target, and sets the interest region R including at least a part of the detection target.

Meanwhile, in the EVS 12, in the case where the posture or position of the person who is the user changes, a change in luminance occurs, and the sensor 121 asynchronously generates the event signal 123 at the pixel address where the change in luminance has occurred.

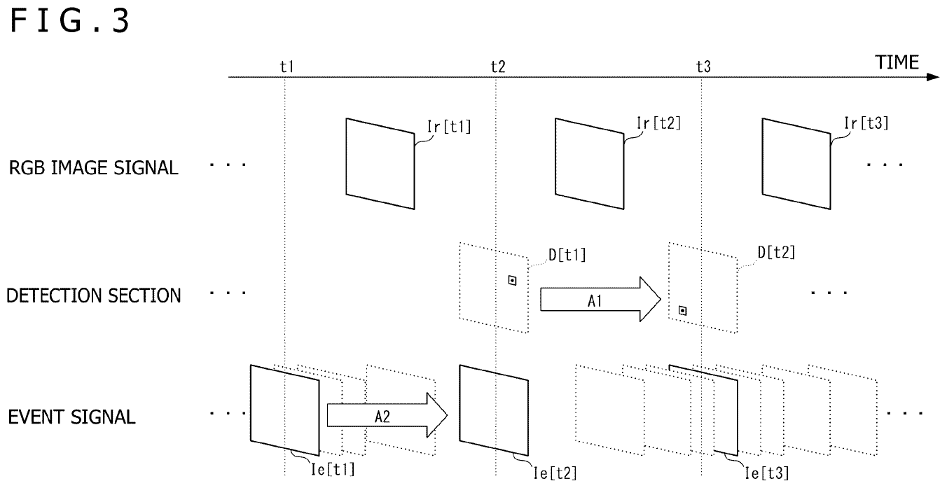

FIG. 3 is a diagram for explaining the relation between the RGB image signal 113 and the event signal 123. In FIG. 3, Ir[tx] indicates the RGB image signal 113 having a timestamp associated with time x, and Ie[tx] indicates the event signal 123 having a timestamp associated with the time x. In addition, for the purpose of explanation, FIG. 3 illustrates an example of a case where the event signals 123 are also generated at predetermined times (t1, t2, and t3) when the RGB image signals 113 are generated, the event signals 123 generated at the predetermined times (t1, t2, and t3) are indicated by solid lines, and the event signals 123 generated at other times are depicted by dotted lines. As described above, since the event signal 123 is generated asynchronously in time, in the case where the event signal 123 is not generated at the predetermined time described above, for example, the event signal 123 to which the timestamp 124 of a close time is given is used.

As depicted in FIG. 3, the RGB image signal 113 is generated at a predetermined cycle, while the event signal 123 is generated asynchronously in time. In addition, the event signal 123 is generated at a frequency significantly higher than the generation frequency of the RGB image signal 113 (the frame rate of the RGB camera 11).

In addition, Ir[t1] that is the RGB image signal 113 having a timestamp of t1 is generated later than time t1, and Ie[t1] that is the event signal 123 having a timestamp of t1 is generated approximately at the time t1. That is, the event signal 123 is relatively high in immediacy and is generated only when a change in luminance is detected. Meanwhile, the RGB image signal 113 is generated later than the event signal 123 at an approximately constant cycle.

At the timing when the RGB image signal 113 is generated, the detection section 21 detects the attention point on the basis of the RGB image signal 113. A certain period of time is required for detection of the attention point by the detection section 21, and D[t1] that indicates a detection result having a timestamp of t1 is output, for example, at time t2. That is, the detection result of the attention point based on the RGB image signal 113 is generated later than the generation of the RGB image signal 113 at an approximately constant cycle. It should be noted that, in FIG. 3, for the purpose of explanation, it is assumed that the detection result by the detection section 21 is output with a delay of one frame with respect to the frame rate of the RGB camera 11.

Here, the RGB image signal 113 has a larger amount of information than the event signal 123 and includes information of a stationary part unlike the event signal 123. Therefore, the detection section 21 detects the attention point on the basis of the RGB image signal 113, so that the detection can be performed with high accuracy. However, as described above, the event signal 123 is generated at a frequency higher than the generation frequency of the RGB image signal 113 (the frame rate of the RGB camera 11). That is, since the RGB image signal 113 is generated at a lower frequency than the event signal 123, the temporal resolution is inferior.

Thus, the detection section 21 selects whether to refer to the RGB image signal 113 or whether to refer to the event signal 123 when detecting the attention point according to the timing when the RGB image signal 113 is generated as described above.

For example, in the example of FIG. 3, the detection result D[t1] by the detection section 21 is output at the time t2 on the basis of the RGB image signal 113 (Ir[t1] ) having a timestamp of t1. Thereafter, it is possible to estimate that the detection result is correct for a predetermined period of time, but in the case where the timing of generation of the RGB image signal 113 and output of the detection result by the detection section 21 is not reached thereafter in spite of, for example, a movement of the attention point, there is a possibility that the movement of the attention point occurring during the time cannot be captured.

Therefore, when a predetermined period of time elapses after the generation of the RGB image signal 113, the detection section 21 refers to the event signal 123 when detecting the attention point. It should be noted that the predetermined period of time may be fixed or may be set each time. For example, the predetermined period of time may be set according to the frame rate of the RGB camera 11 or may be set on the basis of a user operation. Further, the predetermined period of time may be approximately 0. In this case, the detection of the attention point based on the RGB image signal 113 may be started, or the detection of the attention point based on the event signal 123 may be started immediately after the start.

As described above, the RGB image signal 113 is generated later than the event signal 123. That is, the event signal 123 is generated prior to the RGB image signal 113. Therefore, when detecting the attention point, the detection section 21 refers to the event signal 123 that is generated with temporal correlation with time for specifying the RGB image signal 113 referred to by the detection section 21. The time for specifying the RGB image signal 113 is, for example, the exposure start time of the image sensor 111, the output time of the RGB image signal 113, the generation time of an image based on the RGB image signal 113, and the like. For example, when detecting the attention point, the detection section 21 refers to the event signal 123 to which a timestamp associated with the timestamp given to the RGB image signal 113 referred to by the detection section 21 is given.

For example, in the example of FIG. 3, the detection section 21 outputs the detection result D[t1] on the basis of the RGB image signal 113 (Ir[t1] ) having a timestamp of t1 at the time t2, and after a predetermined period of time elapses, detection is performed on the basis of the event signals 123 including the event signal 123 (Ie[t1] ) generated in advance and having a timestamp of t1. In the detection of the attention point based on the event signal 123, the detection section 21 performs detection by, for example, calculating an optical flow indicating the movement of the attention point on the basis of a plurality of event signals 123.

That is, in FIG. 3, in the period indicated by an arrow Al from the output of the detection result D[t1] of the attention point based on the RGB image signal 113 (Ir[t1] ) to the output of the detection result D[t2] of the attention point based on the RGB image signal 113 (Ir[t2]), detection is performed on the basis of the event signals 123 including the event signal 123 (Ie[t1] ) to which a timestamp associated with the timestamp given to the RGB image signal 113 (Ir[t1]) is given, as indicated by the period of an arrow A2.

Then, the detection result D[t2] is output by the detection section 21 at time t3 on the basis of the RGB image signal 113 (Ir[t2] ) having a timestamp of t2. Thereafter, either detection of the attention point based on the RGB image signal 113 or detection of the attention point based on the event signal 123 is similarly executed.

It should be noted that the event signals 123 generated in advance preferably include the event signal 123 to which a timestamp matching the timestamp given to the RGB image signal 113 is given, or the event signal 123 to which a timestamp indicating a time earlier than the timestamp given to the RGB image signal 113 is given, but these event signals 123 may be accumulated in a buffer or recorded as image data. For example, in the case where the event signals 123 are grouped by timestamps within the same or fixed range and the event signals 123 are accumulated in a buffer as data indicating the presence or absence of an event, the polarity of the event, and the like, processing can be performed on an event basis when referring to later. Hereinafter, a case where the event signals 123 are accumulated in a buffer, which is not illustrated, in the detection section 21 will be described as an example.

It should be noted that, in the case where the position of the interest region R is significantly different when the target to be referred to by the detection section 21 when detecting the attention point is changed from the event signal 123 to the RGB image signal 113, the interest region R abruptly changes. In such a case, the detection section 21 may be configured to change the interest region R gradually or stepwise. Further, a difference between the detection result of the attention point based on the event signal 123 and the detection result of the attention point based on the RGB image signal 113 may be obtained, and the method of changing the interest region R may be changed according to the difference.

As described above, the detection section 21 performs detection on the basis of the RGB image signal 113 according to the timing when the RGB image signal 113 is generated, and performs detection on the basis of the event signal 123 in at least a part of the period until the RGB image signal 113 is newly generated next. Therefore, it is possible to perform detection using the RGB image signal 113 preferentially at the timing when the detection result of the attention point based on the RGB image signal 113 is output after the RGB image signal 113 is generated and to perform detection using the event signal 123 supplementarily for the period until the RGB image signal 113 is generated next. In the detection of the attention point based on the event signal 123, since the position itself of the event signal 123 in a region associated with the set interest region R corresponds to the coordinate information of the attention point, the detection section 21 can detect the attention point with high accuracy on the basis of the position where the event signal 123 has occurred, the polarity, and the like.

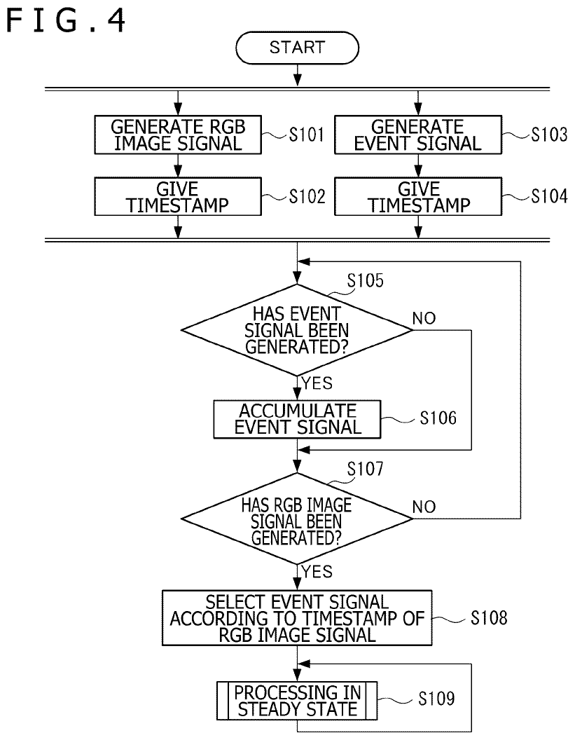

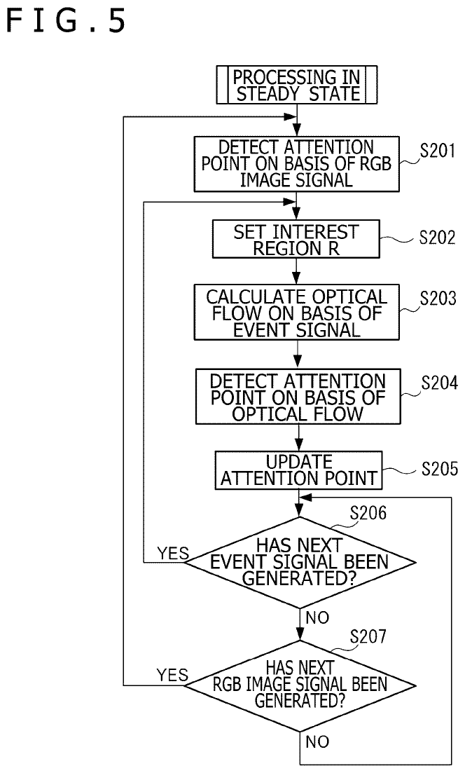

FIG. 4 and FIG. 5 are flowcharts for depicting an example of processing according to an embodiment of the present invention. In the example of FIG. 4, the RGB camera 11 generates the RGB image signal 113 (Step S101), and the timestamp 114 is given to the generated RGB image signal 113 (Step S102). Meanwhile, the EVS 12 generates the event signal 123 in parallel to the generation of the RGB image signal 113 in time (Step S103), and the timestamp 124 is given to the generated event signal 123 (Step S104). The timestamp 114 given to the RGB image signal 113 and the timestamp 124 given to the event signal 123 have temporal correlation. That is, by referring to the timestamp 114 and the timestamp 124, it is possible to later identify the event signal 123 generated with temporal correlation with time for specifying the RGB image signal 113.

It should be noted that Step S103 in which the event signal 123 is generated is executed only in the case where the sensor 121 associated with one or more pixels of the RGB image signal 113 detects a change in the intensity of light. That is, for example, in the case where there is a movement of the attention point, a plurality of event signals 123 are generated while the RGB image signal 113 is generated once.

The detection section 21 determines whether or not the event signal 123 has been generated by the EVS 12 (Step S105), and if it is determined that the event signal 123 has been generated (YES in Step S105), the generated event signal 123 is accumulated in a buffer that is not illustrated (Step S106). It should be noted that the timestamp 124 is given to the event signal 123 as described above.

If it is determined that the event signal 123 is not generated after a predetermined period of time elapses (NO in Step S105), the detection section 21 determines whether or not the RGB image signal 113 has been generated by the RGB camera 11 (Step S107), and if it is determined that the RGB image signal 113 has been generated (YES in Step S107), the flow proceeds to Step S108 to be described later. In contrast, if it is determined that the RGB image signal 113 is not generated after a predetermined period of time elapses (NO in Step S107), the detection section 21 returns to Step S105. That is, until the RGB image signal 113 is generated, the detection section 21 accumulates the event signal 123 in a buffer, which is not illustrated, each time the event signal 123 is generated.

If it is determined that the RGB image signal 113 has been generated (YES in Step S107), the detection section 21 selects a part of the event signals 123 from those accumulated in the buffer according to the timestamp 114 given to the generated RGB image signal 113 (Step S108).

As described above, the event signal 123 is generated prior to the RGB image signal 113. Therefore, the detection section 21 refers to the timestamp 114 given to the generated RGB image signal 113 and the timestamp 124 given to the event signal 123, and selects the event signal 123 generated with temporal correlation with time for specifying the generated RGB image signal 113. By making such a selection, the event signal 123 generated without temporal correlation with time for specifying the generated RGB image signal 113 can be excluded, and the RGB image signal 113 and the event signal 123 can have temporal correlation. It should be noted that the event signal 123 that has not been selected may be processed in any manner such as being erased from the buffer.

The series of processing from Step S105 to Step S108 described so far is an initial processing procedure for allowing the RGB image signal 113 and the event signal 123 to have temporal correlation. The method of the initial processing procedure is not limited to this example.

Then, the detection section 21 executes processing in the steady state (Step S109).

In the example of FIG. 5, in the processing in the steady state, the detection section 21 detects the attention point on the basis of the RGB image signal 113 (Step S201), and sets the interest region R for each detected attention point (Step S202).

Next, the detection section 21 calculates an optical flow on the basis of the event signal 123 (Step S203), and detects the attention point in the interest region R (Step S204). Then, the detection section 21 updates the target of detection to the attention point newly detected in Step S204 (Step S205).

Next, the detection section 21 determines whether or not the event signal 123 has been generated by the EVS 12 (Step S206), and if it is determined that the event signal 123 has been generated (YES in Step S206), the flow returns to Step S202.

That is, the detection section 21 repeatedly executes the processing from Step S202 to Step S206 each time the event signal 123 is generated.

Then, if it is determined that the event signal 123 is not generated after a predetermined period of time elapses (NO in Step S206), the detection section 21 determines whether or not the RGB image signal 113 has been generated by the RGB camera 11 (Step S207), and if it is determined that the next RGB image signal 113 has been generated (YES in Step S207), the detection section 21 returns to Step S201. That is, the detection section 21 repeatedly executes the processing from Step S201 to Step S207 each time the RGB image signal 113 is generated.

Meanwhile, if it is determined that the RGB image signal 113 is not generated after a predetermined period of time elapses (NO in Step S207), the detection section 21 returns to Step S206.

It should be noted that the detection of the attention point based on the RGB image signal 113 in Step S201 includes the following two patterns of processing.

### (1) Processing of Step S201 for the First Time

In the processing of Step S201 for the first time, the detection section 21 detects the attention point on the basis of the RGB image signal 113 that is the target of determination in Step S107 of the initial processing procedure described with reference to FIG. 4.

### (2) Processing of Step S201 From the Second Time

In the processing of Step S201 from the second time, the detection section 21 detects the attention point on the basis of the RGB image signal 113 that is the target of determination in previous Step S207 in the processing in the steady state described with reference to FIG. 5. At this time, the detection section 21 may consider information of the previously detected attention point. That is, the detection section 21 does not detect the attention point on the basis of the RGB image signal 113 that is the target of determination in previous Step S207, but may use information of the previously detected attention point. For example, the information of the previously detected attention point may be used to narrow down the region in which the attention point is detected this time. In addition, for example, detection of the attention point may be performed by reflecting the both information such as appropriately performing weighting and addition according to the difference between the position of the previously detected attention point and the position of the attention point detected on the basis of only the RGB image signal 113 that is the target of determination in previous Step S207.

In addition, the setting of the interest region R in Step S202 includes the following three patterns of processing.

### (1) Processing of Step S202 for the First Time

In the processing of Step S202 for the first time, the detection section 21 sets the interest region R for each attention point detected on the basis of the RGB image signal 113 that is the target of determination in Step S107 of the initial processing procedure described with reference to FIG. 4.

### (2) Processing in the case where it is determined in Step S206 that the event signal 123 has been generated in the processing of Step S202 from the second time

In the case where it is determined in Step S206 that the event signal 123 has been generated, the detection section 21 sets, in the processing of Step S202, the interest region R for each attention point updated in previous Step S205 in the processing in the steady state described with reference to FIG. 5.

### (3) Processing in the case where it is determined in Step S207 that the RGB image signal 113 has been generated in the processing of Step S202 from the second time

In the case where it is determined in Step S207 that the RGB image signal 113 has been generated, the detection section 21 sets, in the processing of Step S202, the interest region R for each attention point newly detected in previous Step S201 in the processing in the steady state described with reference to FIG. 5.

In the processing in the steady state, the detection section 21 complementarily executes the detection of the attention point based on the RGB image signal 113 and the detection of the attention point based on the event signal 123 at an appropriate timing by repeating the processing from Steps S201 to S207. Therefore, the detection can be performed with high accuracy while suppressing latency.

It should be noted that, in the processing in the steady state, as described above, first processing from Step S201 to Step S207, which is repeatedly executed each time the RGB image signal 113 is generated, and second processing from Step S202 to Step S206, which is executed each time the event signal 123 is generated, are complementarily executed, but the cycle of the second processing is generally faster than the cycle of the first processing. This is because the event signal 123 is generated at a frequency significantly higher than the generation frequency of the RGB image signal 113 (the frame rate of the RGB camera 11) as described above.

It should be noted that the detection method described with reference to FIG. 4 and FIG. 5 and other detection methods may be switched and executed. The switching of the detection method may be performed according to a user operation, or may be automatically performed by the information processing device 20. For example, the detection method may be switched according to the purpose of detection, the accuracy and speed required for detection, and the like. In addition, the detection method may be switched according to the status of use of the system 1, the amount of power supply remaining in the system 1, and the like.

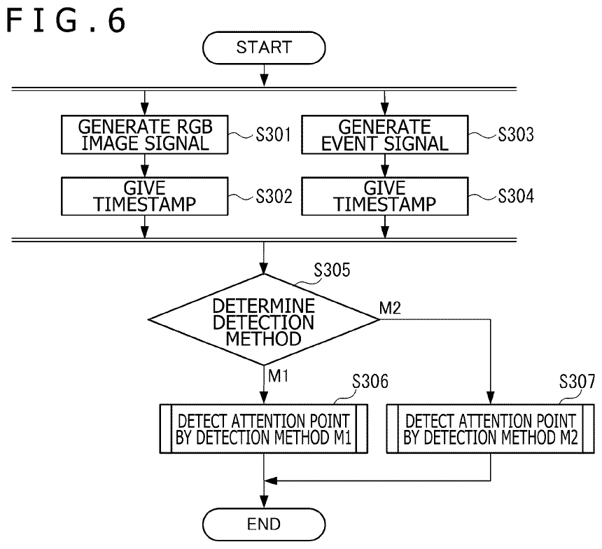

FIG. 6 is a flowchart for depicting an example of another processing of the system 1 according to an embodiment of the present invention. In the illustrated example, a first detection method M1 described with reference to FIG. 4 and FIG. 5 and a second detection method M2 different from the first detection method are switched and executed.

In FIG. 6, each processing from Steps S301 to S304 is similar to each processing from Steps S101 to S104 in FIG. 4, and the description thereof is omitted.

When the detection method is determined (Step S305) and it is determined that the first detection method M1 is selected, the first detection method M1 described at Steps S105 to S109 in FIG. 4 and Steps S201 to S207 in FIG. 5 is executed (Step S306). Meanwhile, if it is determined that the second detection method M2 is selected, the second detection method M2 is executed (Step S307).

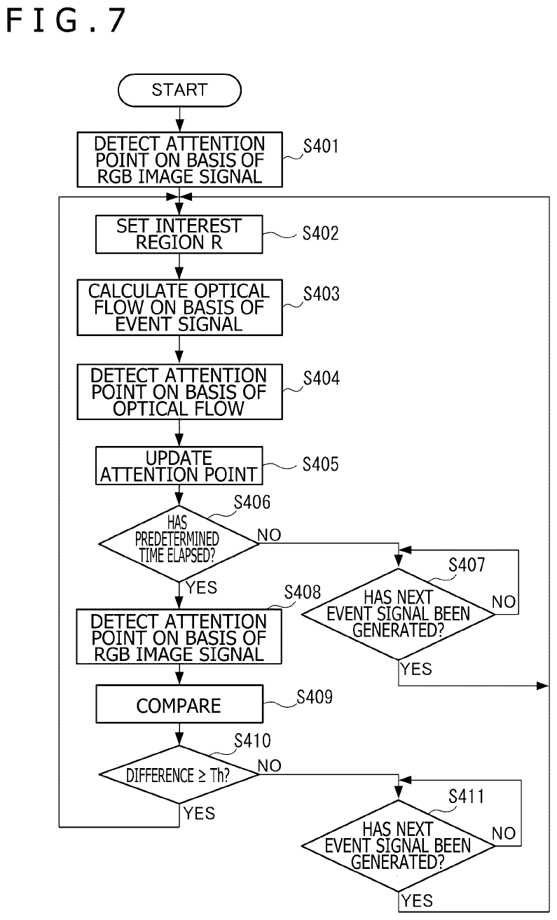

FIG. 7 is a flowchart for depicting an example of another processing of the system 1 according to an embodiment of the present invention. In the example of FIG. 7, as an example of the second detection method M2, an example of a detection method that can perform detection by effectively utilizing the characteristics of an event-based sensor such as a wide dynamic range, a high temporal resolution, and characteristics independent of the background by supplementarily using the RGB image signal 113 is depicted on the basis of the detection of the attention point based on the event signal 123.

In FIG. 7, each processing from Steps S401 to S405 is similar to each processing from Steps S201 to S205 in FIG. 5, and description thereof is omitted.

Then, the detection section 21 determines whether or not a predetermined period of time has elapsed (Step S406), and until the predetermined period of time has elapsed, the detection of the attention point based on the event signal 123 after Step S402 is performed each time the event signal 123 is generated (YES in Step S407), and when the predetermined period of time has elapsed (YES in Step S406), the detection section 21 detects the attention point on the basis of the RGB image signal 113 (Step S408).

Then, the detection section 21 compares the attention point on the basis of the event signal 123 with the attention point based on the RGB image signal 113 (Step S409), and while the difference is less than a predetermined threshold value Th (NO in Step S410), the detection of the attention point based on the event signal 123 after Step S402 is performed each time the event signal 123 is generated (YES in Step S411), and if it is determined that the difference is equal to or larger than the predetermined threshold value Th (YES in Step S410), the flow returns to Step S402, and the detection section 21 sets the interest region R on the basis of the detection result of the attention point in Step S408.

In the second detection method M2, detection is performed while maintaining and resetting the interest region R at an appropriate timing by repeating the processing from Steps S402 to S411 described above. Therefore, the detection can be performed with high accuracy while suppressing latency.

It should be noted that the second detection method M2 is not limited to this example. In addition, three or more detection methods may be appropriately switched.

In addition, when the attention point is detected on the basis of the event signal 123, the following processing may be performed according to the nature of the event signal 123. As described above, the event signal 123 is generated when a change in the intensity of light incident on each pixel, more specifically, a change in luminance exceeding a preset predetermined value is detected. Therefore, the generation frequency of the event signal 123 depends on the amount of movement of an object. For example, the generation frequency of the event signal 123 largely differs among an object that slowly moves, an object that quickly moves, and a stationary object that does not move. In addition, the generation frequency of the event signal 123 also depends on the texture of an object. For example, the generation frequency of the event signal 123 becomes high in the case of an object having a reflective surface such as a window on the surface, or a texture having many irregularities such as ornamentation.

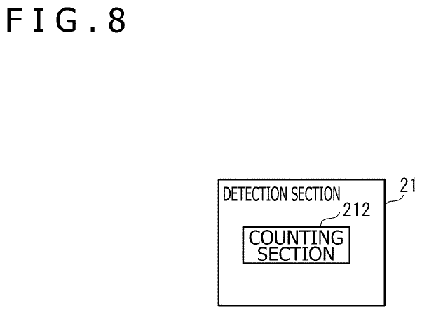

Therefore, it is preferable to perform detection of the attention point based on the event signal 123 at the generation frequency of the event signal 123 and at the timing when the amount of the event signals 123 suitable for detection of the attention point based on the event signal 123 is generated. FIG. 8 is a block diagram for depicting an outline configuration of the detection section 21. As depicted in FIG. 8, the detection section 21 is provided with a counting section 212.

The counting section 212 counts the amount of events of the event signals 123 in the attention region associated with the interest region on the basis of the event signals 123. Here, the amount of events is, for example, the number of event signals 123 per unit time. If it is determined that the number of event signals 123 counted by the counting section 212 within a predetermined period exceeds a predetermined threshold value, the detection section 21 detects the attention point on the basis of the event signals 123.

It should be noted that the amount of events is not limited to the number of event signals 123 per unit time described above.

For example, the distribution of the event signals 123 may be calculated by performing weighting processing on the basis of a distance from the center of each attention region to the event signal 123 and the like, and the calculated distribution may be used as the amount of events. When the distribution is calculated, the distribution may be calculated on a logarithmic scale. By calculating the distribution in this way, it is possible to calculate the distribution in which the influence of a change in ambient brightness is suppressed. In particular, by calculating the distribution on a logarithmic scale, it is possible to calculate accurate distribution even in a dark scene at which the EVS 12 is not good.

In addition, in the case where a plurality of interest regions are set, the counting section 212 sets each of the plurality of interest regions as the attention region, and counts the number of event signals 123 for each attention region.

In the case where the amount of events counted by the counting section 212 satisfies a predetermined condition, the detection section 21 detects the attention point on the basis of the event signal 123. At this time, the detection section 21 detects the attention point on the basis of the event signal 123 at a shorter time interval as the amount of events is larger, and detects the attention point on the basis of the event signal 123 at a longer time interval as the amount of events is smaller.

As described above, the timing suitable for detecting the attention point on the basis of the event signal 123 differs depending on an object. The counting section 212 counts the amount of events for each attention region associated with the interest region, and in the case where the amount of counted events satisfies a predetermined condition, the attention point is detected on the basis of the event signal 123, so that suitable detection can be performed according to characteristics such as the speed of movement of an object and characteristics such as texture for each interest region.

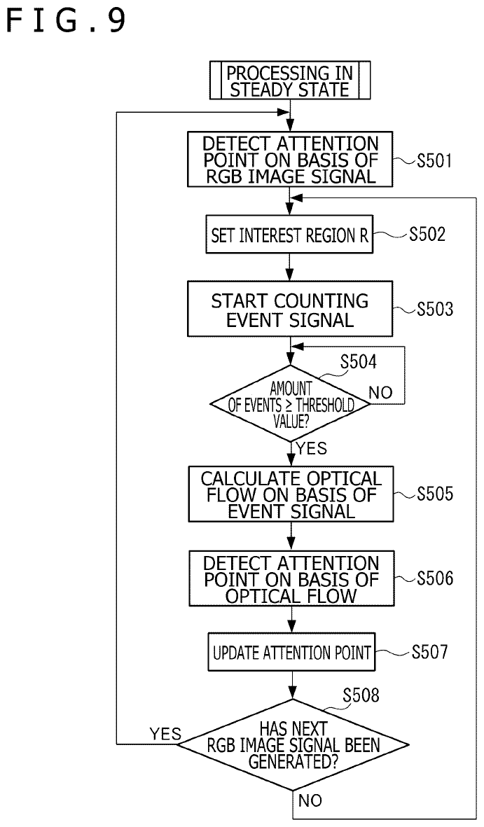

FIG. 9 is a flowchart for depicting an example of another processing of the system 1 according to an embodiment of the present invention.

In FIG. 9, each processing of Steps S501 and S502 is similar to each processing of Steps S201 and S202 in FIG. 5, and description thereof is omitted.

Next, the counting section 212 starts counting the amount of events of the event signals 123 in the attention region associated with the interest region (Step S503), and determines whether or not the amount of events has exceeded a threshold value (Step S504).

Then, if the amount of events exceeds the threshold value (YES in Step S504), the detection section 21 determines that the amount of counted events satisfies a predetermined condition, calculates an optical flow on the basis of the event signal 123 (Step S505), and detects the attention point in the interest region R (Step S506). Then, the detection section 21 updates the target of detection to the attention point newly detected in Step S506 (Step S507).

The detection section 21 determines whether or not the RGB image signal 113 has been generated by the RGB camera 11 (Step S508), and if it is determined that the RGB image signal 113 has been generated (YES in Step S508), the flow returns to Step S501. Meanwhile, if it is determined that the RGB image signal 113 is not generated after a predetermined period of time elapses (NO in Step S508), the detection section 21 returns to Step S502. That is, until the RGB image signal 113 is generated, the detection section 21 repeatedly executes the processing from Steps S502 to S508 to detect the attention point on the basis of the event signal 123 at a suitable timing. Then, each time the RGB image signal 113 is generated, the processing from Step S501 to Step S508 is repeatedly executed.

It should be noted that, in the case where a plurality of interest regions are set, each section executes the processing from Steps S503 to S508 for each of the plurality of interest regions set in Step S502.

In the embodiment of the present invention as described above, the attention point in the detection target is detected on the basis of the RGB image signal 113 that is an output of the first sensor (image sensor 111) and the event signal 123 that is generated with temporal correlation with time for specifying the output of the RGB image signal 113 among the event signals 123 generated by the second sensor (sensor 121).

Therefore, detection can be performed by preferentially utilizing the RGB image signal 113 that is an output of the first sensor, and detection can be supplementarily performed on the basis of the event signal 123 that is relatively high in temporal resolution. That is, the detection result of the attention point based on the output of the first sensor is interpolated with the detection result of the attention point on the basis of the event signal 123 that has been generated in advance in the past. Therefore, since the detection of the attention point based on the event signal 123 can be performed prior to the output of the detection result of the attention point based on the output of the first sensor, it is possible to detect quick motion and smooth movement of the attention point in comparison with the detection using only the RGB image signal 113 that is an output of the first sensor and the detection in which linear interpolation is applied to the RGB image signal 113. Thus, the detection can be performed with high accuracy while suppressing latency.

In addition, in the embodiment of the present invention, detection of the attention point in the detection target is performed by using the RGB image signal 113 that is an output of the first sensor and the event signal 123 that is generated by the second sensor, both of which are sensors that perform an output with temporal correlation with each other, so that the detection can be performed with high accuracy while suppressing latency. In addition, effective detection can be performed in accordance with the respective characteristics of the first sensor and the second sensor.

In addition, in the embodiment of the present invention, when selecting the event signal 123 to be referred to, the detection section 21 selects the event signal 123 generated with temporal correlation with the output of the RGB image signal 113 that is referred to when detecting the attention point by the detection section 21. Thus, the detection can be performed with high accuracy while suppressing latency by effectively utilizing the event signal 123 that has been generated in advance.

In addition, in the embodiment of the present invention, the detection target is a person, and the detection section 21 calculates coordinate information of at least one joint of the person. Thus, the detection can be performed with high accuracy while suppressing latency by using the person as the detection target.

In addition, in the embodiment of the present invention, the counting section 212 for counting the amount of events of the event signals 123 in the attention region including the attention point based on the event signals 123 is provided, and the detection section 21 detects the attention point according to at least the event signals 123 in the case where the amount of events counted within a predetermined period satisfies a predetermined condition. Thus, detection of the attention point based on the event signal 123 can be performed at an optimum timing. In addition, detection of the attention point can be performed with high accuracy for various objects by making the timing of detection of the attention point variable.

In addition, in the embodiment of the present invention, the detection section 21 detects a plurality of attention points, the counting section 212 counts the amount of events for each of a plurality of attention regions, and the detection section 21 detects the attention point for each of the plurality of attention regions on the basis of at least the event signal 123 according to the timing for satisfying a predetermined condition. Therefore, the attention point can be detected in accordance with the characteristics of each of the plurality of attention points.

In addition, in the embodiment of the present invention, the first sensor includes the image sensor 111 that is an image sensor for generating image signals. Thus, it is possible to perform detection by preferentially utilizing the RGB image signal 113 that has a relatively large amount of information, and to supplementarily perform detection on the basis of the event signal 123 that is relatively high in temporal resolution. That is, the detection result of the attention point based on the RGB image signal 113 is interpolated with the detection result of the attention point on the basis of the event signal 123 that has been generated in advance. Therefore, since the detection of the attention point based on the event signal 123 can be performed prior to the output of the detection result of the attention point based on the RGB image signal 113, it is possible to detect quick motion and smooth movement of the attention point in comparison with the detection using only the RGB image signal 113 and the detection in which linear interpolation is applied to the RGB image signal 113. Thus, the detection can be performed with high accuracy while suppressing latency.

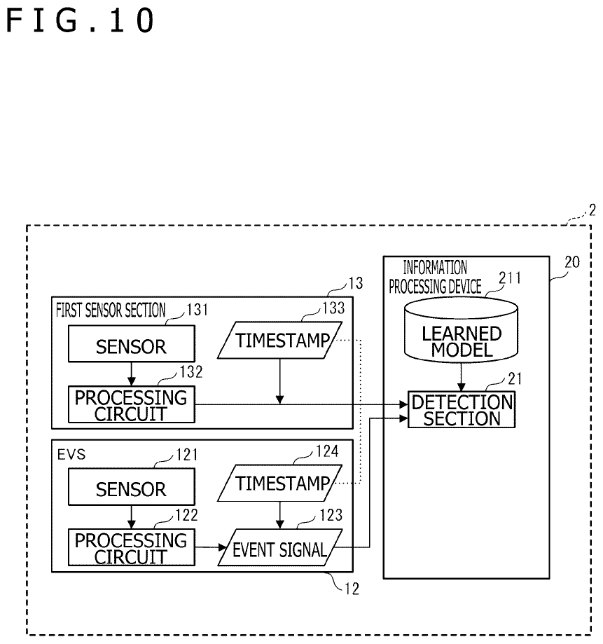

It should be noted that, in the embodiment of the present invention, the image sensor 111 that is an image sensor for generating image signals is exemplified as the first sensor, but the present invention is not limited to this example. For example, the first sensor may be an image sensor for generating image signals other than the RGB image signal 113. In addition, the first sensor may be a sensor other than the image sensor. FIG. 10 is another block diagram for depicting an outline configuration of a system according to an embodiment of the present invention.

As depicted in FIG. 10, a system 2 includes a first sensor section 13 instead of the RGB camera 11 of the system 1 described in FIG. 1. It should be noted that, in the following description, parts that are the same or substantially the same as those already described are denoted by the same reference signs and the description thereof is omitted.

The first sensor section 13 includes a sensor 131 that is a first sensor and a processing circuit 132. Then, the sensor 131 acquires information related to the detection of the attention point, for example, at a predetermined cycle or at a predetermined timing according to a user operation. As the sensor 131, for example, a depth sensor for detecting a three-dimensional structure, a sensor for acquiring position information from a global positioning system (GPS) satellite, a sensor for imaging a non-repetitive pattern such as an augmented reality (AR) marker used for position estimation, an inertial measurement unit (IMU) that is a sensor for detecting a posture, a sensor for self-position estimation by simultaneously localization and mapping (SLAM), and the like can be applied.

The processing circuit 132 converts an output of the sensor 131 into a format suitable for storage and transmission. In addition, the processing circuit 132 gives a timestamp 133 to the output of the sensor 131. Hereinafter, the output of the sensor 131 converted by the processing circuit 132 and given the timestamp 133 is referred to as an “output of the sensor 131.”

In the system 2, the timestamp 133 given to the output of the sensor 131 and the timestamp 124 given to the event signal 123 are temporally associated with each other. Specifically, for example, time information used for generating the timestamp 124 by the EVS 12 is provided to the first sensor section 13, so that the timestamp 133 can be associated with the timestamp 124. Alternatively, in the case where the time information used for generating the timestamps 133 and 124 is independent between the first sensor section 13 and the EVS 12, the offset amount of the timestamps is calculated on the basis of the time when a specific event (for example, a change in a subject throughout an image) occurred, so that the timestamp 133 and the timestamp 124 can be associated with each other after the occurrence.

In addition, in the system 2, the sensor 121 of the EVS 12 and the sensor 131 of the first sensor section 13 are associated with each other by the calibration procedures of the first sensor section 13 and the EVS 12, which are executed in advance, as similar to the system 1 described in FIG. 1.

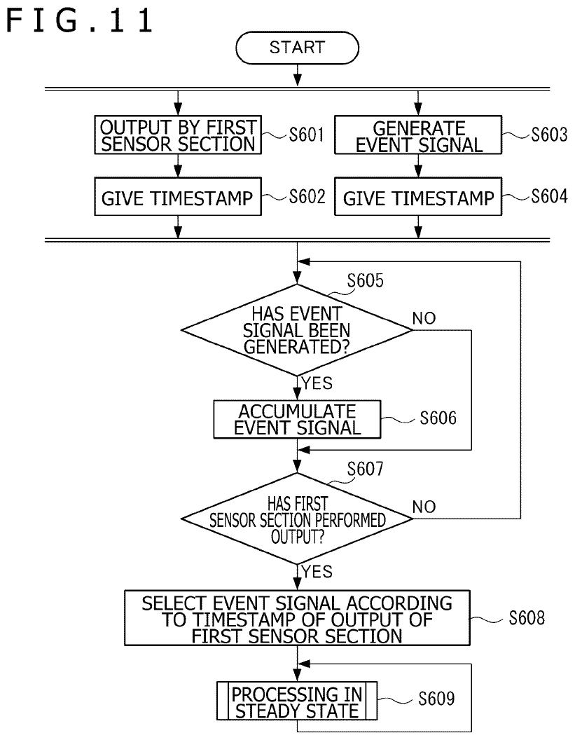

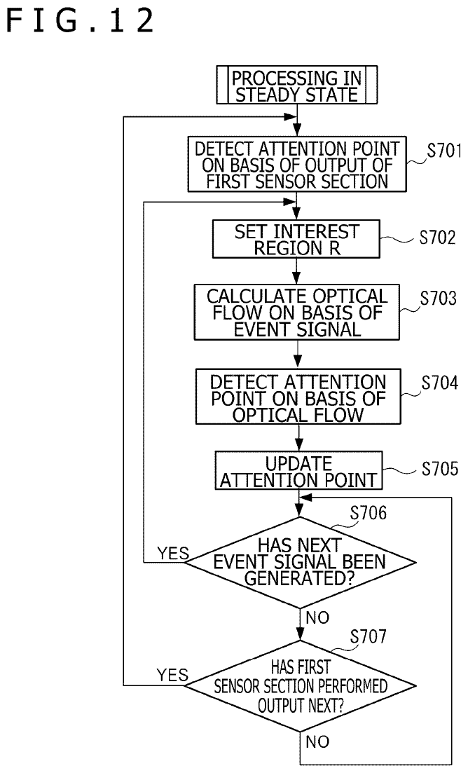

FIG. 11 and FIG. 12 are flowcharts for depicting an example of processing in the system 2. It should be noted that FIG. 11 and FIG. 12 correspond to the flowcharts of FIG. 4 and FIG. 5 described in relation to the system 1, respectively. In the following description, description of parts that are the same or substantially the same as those in FIG. 4 and FIG. 5 will be omitted.

In the example of FIG. 11, the first sensor section 13 performs an output (Step S601), and the timestamp 133 is given to the output of the first sensor section 13 (Step S602).

Step S603 to Step S606 are similar to Step S103 to Step S106 in FIG. 4, respectively.

The detection section 21 determines whether or not the output has been performed by the first sensor section 13 (Step S607), and if it is determined that the output has been performed by the first sensor section 13 (YES in Step S607), the flow proceeds to Step S608 to be described later. Meanwhile, if it is determined that the output is not performed by the first sensor section 13 after a predetermined period of time elapses (NO in Step S607), the detection section 21 returns to Step S605. That is, until the output is performed by the first sensor section 13, the detection section 21 accumulates the event signal 123 in a buffer, which is not illustrated, each time the event signal 123 is generated.

If it is determined that the output has been performed by the first sensor section 13 (YES in Step S607), the detection section 21 selects a part of the event signals 123 among those accumulated in the buffer according to the timestamp 133 given to the output by the first sensor section 13 (Step S608). The detection section 21 refers to the timestamp 133 given to the output by the first sensor section 13 and the timestamp 124 given to the event signal 123, and selects the event signal 123 generated with temporal correlation with time for specifying the output by the first sensor section 13.

The series of processing from Step S605 to Step S608 described so far is an initial processing procedure for allowing the output by the first sensor section 13 and the event signal 123 to have temporal correlation. The method of the initial processing procedure is not limited to this example.

Then, the detection section 21 executes processing in the steady state (Step 609).

In the example of FIG. 12, in the processing in the steady state, the detection section 21 detects the attention point on the basis of the output by the first sensor section 13 (Step S701), and sets the interest region R for each detected attention point (Step S702).

Step S703 to Step S706 are similar to Step S203 to Step S206 in FIG. 5, respectively.

Next, the detection section 21 determines whether or not the output has been performed by the first sensor section 13 (Step S707), and if it is determined that the next output has been performed by the first sensor section 13 (YES in Step S707), the flow returns to Step S701. That is, the detection section 21 repeatedly executes the processing from Step S701 to Step S707 each time the next output is performed by the first sensor section 13.

Meanwhile, if it is determined that the next output is not performed by the first sensor section 13 after a predetermined period of time elapses (NO in Step S707), the detection section 21 returns to Step S706.

According to the system 2, as similar to the system 1 described above, the attention point in the detection target is detected on the basis of the output of the first sensor (sensor 131) and the event signal 123 generated with temporal correlation with time for specifying the output of the first sensor among the event signals 123 generated by the second sensor (sensor 121). Thus, detection can be performed by preferentially utilizing the output of the first sensor, and detection can be supplementarily performed on the basis of the event signal 123 that is relatively high in temporal resolution. That is, the detection result of the attention point based on the output of the first sensor is interpolated with the detection result of the attention point on the basis of the event signal 123. Therefore, it is possible to detect quick motion and smooth movement of the attention point in comparison with the detection using only the output of the first sensor and the detection in which linear interpolation is applied to the output of the first sensor. Thus, the detection can be performed with high accuracy while suppressing latency.

In addition, the detection result described in the embodiment of the present invention may be used in any manner. For example, by using the detection result for tracking, it is also useful for a rendering system that uses a user movement for depiction of a computer graphics (CG) model, a mirroring system that reproduces a user movement by a robot or the like, a gaming system that accepts a user operation similar to controllers, and the like.

For example, in the case where the present invention is used for a rendering system, it becomes possible to perform more detailed and highly accurate detection and tracking due to the improvement of temporal resolution and spatial resolution, and thus it becomes possible to reproduce quick, smooth, and fine motion in a CG model.

In addition, the present invention can be similarly applied to, for example, detection of the attention point in which a predetermined vehicle, machine, living substance, or the like other than a person is the detection target, or detection of the attention point in which a predetermined marker or the like is the detection target.

In addition, in the detection section 21 in the information processing device 20 described in the above example, an example of detecting the attention point from the RGB image signal 113 by using the machine learning method has been depicted, but the present invention may have a configuration in which the attention point is detected by using other methods instead of or in addition to machine learning. For example, the attention point may be detected from the RGB image signal 113 by using a known method such as a block matching method or a gradient method.

In addition, the system 1 described in the above example may be implemented in a single device or may be implemented by being distributed in a plurality of devices. For example, the system may be provided with a camera unit including the RGB camera 11 and the EVS 12 and the information processing device 20. In addition, the information processing device 20 may be implemented in a single device or may be implemented by being distributed in a plurality of devices. For example, a part or all of the processing performed by the detection section 21 may be executed by a server communicably connected by an Internet communication network or wireless communication.

Although several embodiments of the present invention have been described in detail with reference to the accompanying drawings, the present invention is not limited to these examples. It is obvious that a person who has ordinary knowledge in the field of the technique to which the present invention belongs can arrive at various modification examples or correction examples within the scope of the technical thought described in the claims, and it is understood that these examples also naturally belong to the technical scope of the present invention.

### Summary of the Present Invention

[1]

An information processing device including:
a detection section that detects an attention point in a detection target on the basis of an output of a first sensor and
an event signal generated with temporal correlation with time for specifying the output of the first sensor among event signals generated by a second sensor including an event-based sensor for asynchronously generating event signals when detecting a change in intensity of light incident on each pixel.
[2]

The information processing device according to [1], in which the event signal to be referred to when the attention point is detected includes the event signal to which a second timestamp associated with a first timestamp given to the output by the first sensor referred to when the attention point is detected is given.
[3]

The information processing device according to [2], in which the event signal to be referred to when the attention point is detected includes at least one of the event signal to which the second timestamp matching the first timestamp is given and the event signal to which the second timestamp indicating time earlier in time than the first stamp is given.
[4]

The information processing device according to any one of [1] to [3], in which the detection section calculates an optical flow indicating a movement of the attention point based on a plurality of the event signals, and detects the attention point on the basis of the output of the first sensor and the optical flow.
[5]

The information processing device according to any one of [1] to [4], in which the detection section sets an interest region including the attention point, and detects the attention point in the interest region.
[6]

The information processing device according to any one of [1] to [5], in which the detection section detects the attention point by referring to at least one of the output of the first sensor and the event signal, according to an output timing of the first sensor.
[7]

The information processing device according to [6], in which the detection section refers to at least the output of the first sensor when the output by the first sensor is performed, and refers to at least the event signal when a predetermined period of time elapses after the output by the first sensor.
[8]

The information processing device according to any one of [1] to [7], in which
the detection target is a person, and
the detection section calculates coordinate information of at least one joint of the person, and detects each joint of the person as the attention point.
[9]

The information processing device according to any one of [1] to [8], including:
a counting section that counts an amount of events of the event signals in an attention region including the attention point within a predetermined period on the basis of the event signals, in which,
in a case where the amount of events counted within the predetermined period satisfies a predetermined condition, the detection section detects the attention point on the basis of at least the event signal.
[10]

The information processing device according to [9], in which the detection section detects a plurality of the attention points,
the counting section counts the amount of events for each of a plurality of the attention regions, and
the detection section detects the attention point for each of the plurality of attention regions on the basis of at least the event signal, according to a timing satisfying the predetermined condition.
[11]

The information processing device according to [1] or [10], in which
the amount of events is the number of event signals per unit time, and,
in a case where the number of event signals exceeds a predetermined threshold value, the detection section detects the attention point on the basis of at least the event signal.
[12]

The information processing device according to any one of [1] to [11], in which the first sensor includes an image sensor for generating an image signal.
[13]

A system including:
a first sensor;
a second sensor that includes an event-based sensor for asynchronously generating event signals when detecting a change in intensity of light incident on each pixel; and
a detection section that detects an attention point in a detection target on the basis of an output of the first sensor and the event signal generated with temporal correlation with time for specifying the output of the first sensor among the event signals.
[14]

An information processing method including:
a first reception step of receiving an output of a first sensor;
a second reception step of receiving event signals generated by
a second sensor including an event-based sensor for asynchronously generating event signals when a change in intensity of light incident on each pixel is detected; and
a detection step of detecting an attention point in a detection target on the basis of the output of the first sensor and an event signal generated with temporal correlation with time for specifying the output of the first sensor among the event signals.
[15]

An information processing program that causes a computer to realize:
a function of receiving an output of a first sensor;
a function of receiving event signals generated by a second sensor including an event-based sensor for asynchronously generating event signals when a change in intensity of light incident on each pixel is detected; and
a function of detecting an attention point in a detection target on the basis of the output of the first sensor and an event signal generated with temporal correlation with time for specifying the output of the first sensor among the event signals.
[16]

A computer system including:
at least one memory for storing a program code; and
at least one processor for processing the program code to execute an operation, in which
the operation includes
receiving an output of a first sensor;
receiving event signals generated by a second sensor including an event-based sensor for asynchronously generating event signals when a change in intensity of light incident on each pixel is detected; and
detecting an attention point in a detection target on the basis of the output of the first sensor and an event signal generated with temporal correlation with time for specifying the output of the first sensor among the event signals.

### REFERENCE SIGNS LIST

1, 2: System
11: RGB camera
12: EVS
13: First sensor section
20: Information processing device
21: Detection section
111: Image sensor
112, 122: Processing circuit
113: RGB image signal
114, 124, 133: Timestamp
121, 131: Sensor
123: Event signal
211: Learned model
212: Counting section

1. An information processing device comprising:
at least one memory having computer program code stored therein; and
at least one processor coupled to the memory, that upon execution of the program code, configured to:
detect an attention point in a detection target on a basis of an output signal of a first sensor and one or more event signals,
wherein the one or more event signals are generated in temporal correlation with the output signal of the first sensor,
wherein the one or more event signals are among a plurality of event signals generated by a second sensor, and
wherein the second sensor comprising an event-based sensor that is configured to asynchronously generate event signals upon detecting a change in intensity of incident light for each pixel.

2. The information processing device according to claim 1, wherein the one or more event signals comprises an event signal given a second timestamp associated with a first timestamp given to the output signal when the attention point is detected.

3. The information processing device according to claim 2, wherein the one or more event signals comprises the event signal given the second timestamp matching the first timestamp, the event signal given the second timestamp indicating time earlier than the first timestamp or a combination thereof.

4. The information processing device according to claim 1, wherein the one or more processors are configured to calculate an optical flow indicating a movement of the attention point on a basis of another plurality of event signals of the one or more event signals, and further configured to detect the attention point on a basis of the output signal of the first sensor and the optical flow.

5. The information processing device according to claim 1, wherein the one or more processors are configured to set an interest region including the attention point, and further configured to detect the attention point in the interest region.

6. The information processing device according to claim 1, wherein the one or more processors are configured to detect the attention point based on at least one of the output signal of the first sensor and the event signal, according to an output timing of the first sensor.

7. The information processing device according to claim 6, wherein the one or more processors are configured to detect the attention point based at least on the output signal of the first sensor when the output by the first sensor is performed, and
wherein the one or more processors are configured to detect the attention point based at least on the event signal when a predetermined period of time elapses after the output signal is output by the first sensor.

8. The information processing device according to claim 1, wherein
the detection target is a person, and
wherein the one or more processors are configured to calculate coordinate information of at least one joint of the person, and further configured to detect each joint of the person as the attention point.

9. The information processing device according to claim 1, wherein the one or more processors are further configured to:
measure an amount associated with events based on the one or more event signals in an attention region including the attention point within a predetermined period on a basis of the one or more event signals, wherein,
if the amount associated with events within the predetermined period satisfies a predetermined condition, the one or more processors are further configured to detect the attention point on a basis of at least the one or more event signals.

10. The information processing device according to claim 9, wherein
the one or more processors are further configured to detect a plurality of attention points,
the one or more processors are further configured to measure an amount associated with events for each of a plurality of attention regions, and
the one or more processors are further configured to detect an attention point for each of the plurality of attention regions on the basis of at least the one or more event signals, according to a timing satisfying the predetermined condition.

11. The information processing device according to claim 9, wherein
the amount [[of ]]associated with events is [[the]] a number of the one or more event signals per unit time, and,
if the number of the one or more event signals per unit exceeds a predetermined threshold value, the one or more processors are further configured to detect the attention point on the basis of at least the number of event signals.

12. The information processing device according to claim 1, wherein the first sensor includes an image sensor configured to generate an image signal.

13. A system comprising:
a first sensor;
a second sensor comprising an event-based sensor that is configured to asynchronously generate a plurality of event signals upon detecting a change in intensity of incident light for each pixel; and
at least one memory having computer program code stored therein; and
at least one processor coupled to the memory, that upon execution of the program code, configured to:
detect an attention point in a detection target on a basis of an output signal of the first sensor and one or more event signals generated in temporal correlation with the output signal of the first sensor among the plurality of event signals.

14. An information processing method comprising:
a receiving an output signal of a first sensor;
receiving one or more event signals, wherein the one or more event signals are generated by a second sensor, and wherein the second sensor including an event-based sensor configured to asynchronously generate a plurality of event signals upon detecting a change in intensity of incident light incident on for each pixel; and
detecting an attention point in a detection target on a basis of the output signal of the first sensor and one or more event signal, wherein the one or more event signals are generated in temporal correlation with the output signal of the first sensor among the plurality of event signals.

15-16. (canceled)

17. The method of claim 14, wherein the one or more event signals comprises an event signal given a second timestamp associated with a first timestamp given to the output signal when the attention point is detected.

18. The method of claim 14, further comprising:
calculating an optical flow indicating a movement of the attention point on a basis of another plurality of event signals of the one or more event signals; and
detecting the attention point on a basis of the output signal of the first sensor and the optical flow.

19. The method of claim 14, further comprising:
setting an interest region including the attention point; and
detecting the attention point in the interest region.

20. The method of claim 14, further comprising:
detecting the attention point based on at least one of the output signal of the first sensor and the event signal, according to an output timing of the first sensor.

21. The method of claim 14, wherein the detection target is a person, and
wherein the method further comprises:
calculating coordinate information of at least one joint of the person; and
detecting each joint of the person as the attention point.

22. The method of claim 14, further comprising:
measuring an amount associated with events based on the one or more event signals in an attention region including the attention point within a predetermined period on a basis of the one or more event signals,
wherein, if the amount associated with events within the predetermined period satisfies a predetermined condition, detecting the attention point on a basis of at least the one or more event signals.
